(19) United States
(12) Patent Application Publication
(10) Pub. No.: US 2011/0068279 A1
(43) Pub. Date: Mar. 24, 2011

(54) ULTRA DARK FIELD MICROSCOPE

(76) Inventor: THEODORE DENIS FAY, JR., Mission Viejo, CA (US)

(21) Appl. No.: 12/853,651

(22) Filed: Aug. 10, 2010

Related U.S. Application Data
(60) Provisional application No. 61/233,001, filed on Aug. 11, 2009.

(51) Int. Cl. G01J 1/58; G02B 21/10

(52) U.S. Cl. 250/459.1; 359/385

(57) ABSTRACT

A fluorescence microscope includes a nearly monochromatic light source, a Brewster angle wedge, and an optical system for irradiating a sample with a light beam from the light source and directing fluorescence light from said sample onto the Brewster angle wedge. Collection optics are provided for focusing a hyper-spectral, wide angle and dark field image of the sample from the Brewster angle wedge onto recording optics.

The present application claims priority from U.S. Provisional Patent Application Ser. No. 61/233,001 filed Aug. 11, 2009. This provisional application is to be incorporated in its entirety into the present application.

The present invention is generally directed to a microscope for monitoring Raman scattering and fluorescence, emitted by a sample. More particularly, the present invention relates to a microscope and method for improved optical detection and sensitivity in situations in which emission of fluorescent light is observed.

Fluorescence microscopy is a powerful tool for analyzing tissues and cells. As opposed to bright field microscopy where light is transmitted through an analyzed sample, in fluorescence microscopy, a signal appears only with respect to specific samples that emit light. In this case the background is left dark.

Because of the dark background, or field, fluorescence microscopy is a very sensitive method for detecting the existence, distribution and quantities of elements in a sample. This is particularly of importance in confocal microscopy wherein an array of fields is measured jointly.

However, current state of the art fluorescence microscopes including confocal microscopes utilize filters and masks for blocking unwanted light, especially scattered light from the excitation source. The present invention provides for a fluorescence microscope without the dependence of such filters and as a result greatly enhances its efficiency.

### SUMMARY OF THE INVENTION

Fluorescence and confocal microscopes in accordance with the present invention provide dark field, wide field, and hyper-spectral imaging capability.

A wedge based dark field, wide field, hyper-spectral fluorescence microscope (WDFM) is hereby so defined that the exciting light from any source emitting light of higher energy than the wedge band gap is blocked by a factor of more than 100,000 billion (10¹⁴), so as to be essentially undetectable by the camera or other detector.

What is detected by the (WDFM) is the Stokes shifted light (as a two dimensional image of sample Raman scattering or from the fluorescence of biomarkers implanted in the sample). Each type of image is a weighted sum over the sample depth of field. Two purposes of such measurements are chemical analyses and image scanning of the biological sample (or sample of any other organic molecule or compound).

In contrast to the WDFM described here, and as hereinabove noted, current state of the art microscopes employ filters that typically block the light to no more than one part in one million. Using multiple filters to further block the light gravely limits sensitivity.

A confocal dark field microscope (CDFM) is defined such that the exciting light from a single laser is blocked by a factor of more than 100,000×billion (10¹⁴), so as to be essentially undetectable by the camera or other detector. The incoherent, Stokes shifted light from each point in a three dimensional image is detected using a depth of field (DOF) isolation mechanism. The DOF isolation may be achieved by utilizing a pinhole to define one point of focus in the depth dimension of the sample.

Again, state of the art confocal microscopes use filters that block the exciting light to no more than one part in one million for same said scanning, thus gravely limiting the molar sensitivity of the microscope image, due to the much lower intensity of the fluorescent image.

More particularly, a fluorescence microscope in accordance with the present invention includes a nearly, or pure, monochromatic light source along with a Brewster angle wedge and an optical system for irradiating a sample with a light beam from the light source and directing fluorescence light from the sample onto the Brewster angle wedge.

Collector optics is provided for focusing a hyper-spectral-wide angle and dark field image of the sample from the Brewster angle wedge onto recording optics.

More specifically, the optical system includes the capability for magnifying the sample and a collimator optic for rendering parallel the fluorescent light onto the Brewster angle wedge.

A filter/beam splitter is provided for blocking off band light from the light source and directing the fluorescent light onto the Brewster angle wedge.

In one embodiment of the present invention, the optical system is configured for establishing confocal focus between the sample and the recording optics.

### BRIEF DESCRIPTION OF THE DRAWINGS

The advantages and features of the present invention will be better understood by the following description when considered in conjunction with the accompanying drawings in which:

FIG. 1 is schematic drawing of an ultra dark field wide angle, wide field, hyper-spectral fluorescence microscope (WDFM) in accordance with the present invention; and

FIG. 2 is a schematic diagram of a confocal dark field microscope (CDFM) embodiment of the present invention.

### DETAILED DESCRIPTION

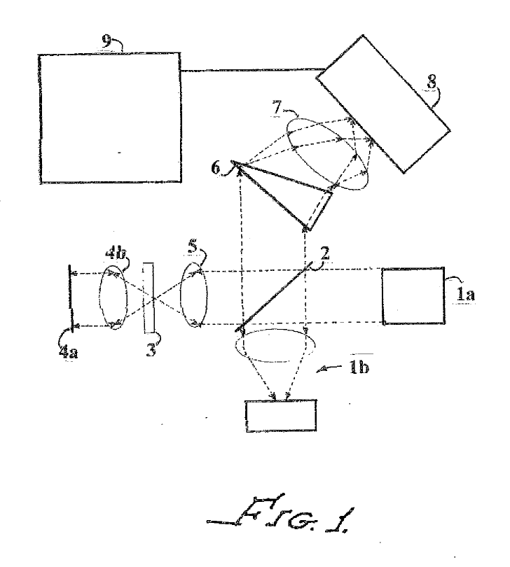

With reference to FIG. 1, there is shown an ultra dark field wide angle, wide field, hyper-spectral fluorescence microscope 1 that generally includes a nearly monochromatic (single wavelength band) light source 1a such as, for example, and LED, a laser, or a laser source as set forth in U.S. Pat. No. 7,286,582 to Fay.

A filter/beam splitter 2 is provided to block off band light from the light source 1 and also direct light into an optical monitor 1b to monitor any fluctuations that might occur in the instant light source 1a. The monitor 1b can be a simple detector or a dispersive spectrometer to measure output of the excitation source versus wavelength. The molarity of the sample (chemical or molecule) is proportional to the ratio of the intensity of the fluorescent light to the source light. The source light must be monitored in order for the computer, 9 to produce an accurate image of the molarity of chemical or molecule as a function of position on the sample.

Light is directed to a specimen 3 utilizing a reflective (such as a Schmidt or Schwarzschild system) or refractive objective (multi-lens), 4b, and 4a (flat of mirror), both of which increase the fluorescence solid angle by collecting the light initially traveling in the opposite direction. This optional feature enables the light source 1a to strike the sample 3 twice resulting in a gain in the fluorescent signal by approximately 4.

A collimating eyepiece lens, or reflective optic, 5, both collimates the fluorescence from the sample and focuses the laser light on the sample. It should be appreciated that the fluorescence signal and laser light are within 20 nm of the same wavelength, which minimizes the chromatic aberration by the objective. It should also be appreciated that most of the light passes through the thin sample 3 so that it can be refocused by the objective lens 4b and reflected by the flat mirror 4a. As hereinabove noted, in this way the intensity of the fluorescence collected by the collimator objective is at least several times that of a conventional microscope.

Since the fluorescent signal emerges in all directions from the sample 3, the collimator 5 will collimate a large fraction of the fluorescent light emitted from the focal spot of the laser light emerging from the source 1a.

Background signals (for example Raman or Rayleigh scattering) can be effectively suppressed by simple shutters and stops (not shown), since the laser light in this focal spot has a high intensity and can be compressed in time as well as space.

The sample 3 can be moved in three dimensions by piezo sensors and controllers (not shown) to access the entire sample 3 not just a specific spot as shown in FIG. 1.

The collimated light from the eyepiece 5 is reflected by the beam splitter 2 by 90° as shown in FIG. 1 and onto a Brewster angle wedge 6, which disperses the light by refraction and blocks the exciting source wavelength by many orders of magnitude. Suitable Brewster angle wedges are described in U.S. Pat. Nos. 7,238,954 B1 and 7,286,582 B1 to Fay. These references are to be incorporated herein in their entirety.

Dispersed light from the wedge 6 passes through a collector eyepiece 7 in order to focus the hyper-spectral, wide angle, and dark field image onto recording optics 8, which may be a camera or the like, which communicates with a computer 9 and software to process the biological or non-biological image into useful pictures for either medical (either in vivo or in vitro), pharmaceutical analysis, or other analysis.

The wedge 6 disperses the light and thereby produces an image at each fluorescent wavelength (hyperspectral image). The wedge also compresses that image in that spectral direction, increasing wavelength resolution and separation. This compression intensifies the image of the fluorescent spot selectively on the surface of the camera 8. Any scattered laser light from the source 1a is blocked by the wedge 6.

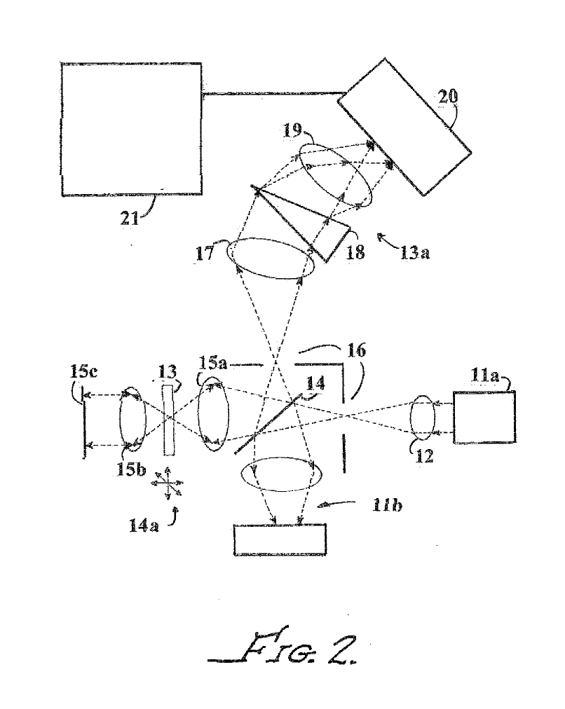

With reference to FIG. 2, there is shown as an alternative embodiment 11 of the present invention a dark field, wide field, hyper-spectral confocal microscope (CDFM) which generally includes an ultra pure single wavelength light source 11a along with the lens assembly 12. This lens enables the focused laser light from the source 11a to share a common focus with the fluorescence of the biological sample 13 at the detector/computer assembly 19-21.

As with the embodiment shown in FIG. 1, a monitor 11b may be provided with a central beam splitter 14 to carry fluorescent light to the monitor 11b.

The sample 13 may be scanned in three dimensions as indicated by the arrow 14a and when combined with appropriate biomarkers are useful for biochemical analysis.

As with the embodiment shown in FIG. 1, a reflective (such as a Schmidt or Schwarzchild system) or refractive objective (multi-lens) 15a, 15b, 15c may be utilized to focus the laser light on to a very small (30 micron sized spot) of the sample and to magnify the fluorescent image at a one micron resolution over a field of up to several degrees in angular size.

As shown in FIG. 2, dual confocal pinholes, 16, act together block out of focus fluorescence from reaching the detector 13a.

As indicated by dashed lines in FIG. 2, a collimator eyepiece lens, or reflective optic 17 is provided to render parallel the light from wedge, 18, dispersion. The wedge, 18, has hereinbefore been described in connection with the embodiment of the present shown in FIG. 1.

A collector eyepiece 19 is provided to focus the hyper-spectral, several micron confocal image of the sample (chemical or molecule) onto recording optics 20, such as a camera. This camera or other detection array is interconnected to a computer 21 to process the image into biologically useful pictures for medical and pharmaceutical analysis over the entire scan field of the image. Confocal microscopes are normally used only invitro (laboratory diagnostic).

Although there has been hereinabove described a specific ultra dark field microscope in accordance with the present invention for the purpose of illustrating the manner in which the invention may be used to advantage, it should be appreciated that the invention is not limited thereto. That is, the present invention may suitably comprise, consist of or consist essentially of the recited elements. Further, the invention illustratively disclosed herein suitably may be practiced in the absence of any element, which is not specifically disclosed herein. Accordingly, any and all modifications, variations, or equivalent arrangements, which may occur to those who are skilled in the art, should be considered to be within the scope of the present invention as defined by the appended claims.

What is claimed is:

1. A fluorescence microscope comprising:
a nearly monochromatic light source;
a Brewster angle wedge;
an optical system for irradiating a sample with a light beam from the light source and directing fluorescence light from said sample onto the Brewster angle wedge; and
collection optics for focusing a hyper-spectral, wide angle and dark field image of the sample from the Brewster angle wedge onto recording optics.

2. The fluorescence microscope according to claim 1 wherein said optical system comprises a filter/beam splitter for blocking off band light from the light source and directing the fluorescence light onto the Brewster angle wedge.

3. The fluorescence microscope according to claim 2 wherein said optical system further comprises magnification optics for magnification of said sample.

4. The fluorescence microscope according to claim 3 wherein said optical system further comprises a collimator optic for rendering parallel fluorescence light onto the Brewster angle wedge.

5. The fluorescence microscope according to claim 1 wherein said optical system is configured for establishing confocal focus between the sample and recoding optics.

6. The fluorescence microscope according to claim 5 wherein said optical system further comprises a beam splitter for directing fluorescent light onto a monitor.

7. The fluorescence microscope according to claim 6 wherein said optical system further comprises confocal apparatus to prevent out-of-focus fluorescence from reaching the recording optics.

8. The fluorescence microscope according to claim 7 wherein said optical system further comprises magnification optics for magnification of said sample.

9. The fluorescence microscope according to claim 8 wherein said optical system further comprises a collimation optic for rendering parallel the fluorescence light onto the Brewster angle wedge.

10. A fluorescence microscopy method comprising:
providing a Brewster angle wedge;
irradiating a sample with a nearly monochromatic light source for producing a fluorescent image of the sample, and a molarity map of specific chemicals or molecules;
directing the fluorescent light onto the Brewster angle wedge to produce a hyper-spectral, wide angle, and dark field image of the sample; and
directing the fluorescent light of the sample onto recording optics.

11. The method according to claim 10 further utilizing a filter/beam splitter to block off based light from the light source and direct the fluorescence light onto the Brewster angle wedge.

12. The method according to claim 11 further comprising magnification of said sample.

13. The method according to claim 12 further comprising providing a collimator optic for rendering parallel fluorescence light onto the Brewster angle wedge.

14. The method according to claim 5, further establishing confocal focus between the sample and recoding optics.

15. The method according to claim 10, further providing a beam splitter for directing fluorescence light onto a monitor.

16. The method according to claim 5, further comprising providing confocal apparatus to prevent out-of-focus fluorescence from reaching the recording optics.

17. The method according to claim 5, further comprising magnification of said sample.

18. The method according to claim 17, further comprising providing a collimation optic for rendering parallel the fluorescence light onto the Brewster angle wedge.
